(19) United States
(12) Patent Application Publication
(10) Pub. No.: US 2026/0268600 A1
(43) Pub. Date: Sep. 10, 2026

(54) Methods of Generating 3-D Maps of Hidden Objects Using Non-Ranging Feature-Detection Data, and Related Software, Apparatuses, and Systems

(71) Applicant: The University of Vermont and State Agricultural College, Burlington, VT (US)

(72) Inventors: Dylan Burns, South Burlington, VT (US); Joshua Girard, Burlington, VT (US); Dryver Huston, South Burlington, VT (US); Tian Xia, South Burlington, VT (US)

(21) Appl. No.: 18/849,369

(22) PCT Filed: Mar. 28, 2023
(86) PCT No.: PCT/US2023/016525

§ 371 Date: Sep. 20, 2024

Related U.S. Application Data
(60) Provisional application No. 63/326,365, filed on Apr. 1, 2022.

(51) Int. Cl. G06T 17/20; G01S 13/88; G01S 13/89; G06T 7/73

(52) U.S. Cl. CPC G06T 17/20; G01S 13/885; G01S 13/89; G06T 7/73; G06T 2207/10028; G06T 2210/21

(57) ABSTRACT

Generating a three-dimensional (3-D) map of an object using feature-presence data, pose data regarding the poses of one or more feature-detection instruments, and/or sensor(s) thereof, when collecting the feature-presence data, and a triangulation algorithm that operates upon the feature-presence data and pose data to determine datapoints indicating presence of the object. In some embodiments, each feature-detecting instrument is a non-ranging instrument that can detect feature presence through material(s) and/or structure(s) that prevent the object from being viewed directly. In some embodiments, the 3-D map is used to generate mixed-reality images that present visualizations of the 3-D map fused with environmental images of the environment in which the object is located. In some mixed-reality applications, the environmental images are acquired using one or more suitable instruments, such as visible-light camera/s), infrared camera(s), and ranging-type sensors (e.g., radar), among others. Related software, apparatuses, and systems are

### RELATED APPLICATION DATA

This application claims the benefit of priority of U.S. Provisional Patent Application Ser. No. 63/326,365, filed Apr. 1, 2022, and titled “APPARATUSES, SYSTEMS, AND METHODS FOR BUILDING IMAGES USING SENSOR POSE INFORMATION”, which is incorporated herein by reference in its entirety.

### GOVERNMENT RIGHTS

This invention was made with government support under: Award N00014-21-1-2326 issued by the Office of Naval Research; Contract W913E521C0003 awarded by the U.S. Army Engineer Research and Development Center (ERDC); and Grant 1647095 awarded by the U.S. National Science Foundation. The government has certain rights in the invention.

### FIELD OF THE INVENTION

The present disclosure generally relates to the field of 3-D mapping of hidden objects. In particular, the present disclosure is directed to methods of generating 3-D maps of hidden objects using non-ranging feature-detection data, and related software, apparatuses, and systems.

### BACKGROUND

Ground-penetrating radar (GPR) is useful for locating underground objects for any of a variety of reasons, such as to avoid damaging the objects during excavation operations and/or to generate maps of underground utilities, among many other things. Single-frequency continuous-wave GPR (CW-GPR) is able to penetrate relatively far into soil or other material. However, conventional handheld single-frequency CW-GPR instruments provide only a binary signal that indicates that an underground object is present or it is not without providing any indication of the depth of the object within the material. Despite the attractiveness of single-frequency CW radar for its ground-penetrating ability, the limited amount of information that conventional handheld single-frequency CW-GPR instruments provide to a user severely limits their usefulness.

### SUMMARY

In one implementation, the present disclosure is directed to a method of creating a 3-D map of an object. The method includes receiving feature-presence information acquired via one or more sensors that sense presence of at least one feature of the object; receiving pose information that correlates to the feature-present information; executing a triangulation algorithm that operates on the feature-presence information and the pose information to determine 3-D locations of feature datapoints indicating presence of the at least one feature at the 3-D locations; and executing a map-building algorithm to build the 3-D map of the object using the feature datapoints.

In another implementation, the present disclosure is directed to a machine-readable hardware storage medium containing machine-executable instructions that performs a method that includes the above method.

In yet another implementation, the present disclosure is directed to a 3-D mapping system, which includes a machine-readable hardware storage medium containing machine-executable instructions for performing the method at the beginning of this Summary section; and a processing system in operative communication with the machine-readable hardware storage medium, wherein the processing system is configured to execute the machine-executable instructions so as to perform any of the methods.

In still another implementation, the present disclosure is directed to a method of creating an image of an object. The method includes receiving feature-presence information acquired via one or more sensors that sense presence of at least one feature of the object; receiving pose information that correlates to the feature-present information; executing a triangulation algorithm that operates on the feature-presence information and the pose information to determine 3-D locations of feature datapoints indicating presence of the at least one feature at the 3-D locations; executing a map-building algorithm to build a 3-D map of the object using the feature datapoints; generating a viewable image of the object using the 3-D map; and displaying the viewable image on a display device.

In another implementation, the present disclosure is directed to an imaging system, which includes a machine-readable hardware storage medium containing machine-executable instructions for performing the method above; and a processing system in operative communication with the machine-readable hardware storage medium, wherein the processing system is configured to execute the machine-executable instructions so as to perform any of the methods.

### BRIEF DESCRIPTION OF THE DRAWINGS

For the purpose of illustration, the accompanying drawings show aspects of one or more embodiments of the invention(s). However, it should be understood that the invention(s) of this disclosure is/are not limited to the precise arrangements and instrumentalities shown in the drawings, wherein:

FIG. 1 is a high-level block diagram illustrating an example 3-D mapping system made in accordance with aspects of this disclosure and example uses of such a mapping system;

FIG. 2 is a flowchart illustrating an example method of creating an image based on a 3-D map made using a 3-D mapping system of the present disclosure, such as the example 3-D mapping system of FIG. 1;

FIG. 3 is a perspective view of an example handheld apparatus that includes a 3-D mapping system made in accordance with aspects of this disclosure and an example non-ranging feature-detection (NRFD) instrument;

FIG. 4 is a diagram illustrating the beam pattern of the NRFD instrument of FIG. 3;

FIG. 5A is a diagram illustrating features of the triangulation algorithm used in the 3-D mapping system of the example handheld apparatus of FIG. 3;

FIG. 5B is a diagram depicting the presence of an inaccurate intersection zone caused by scans originating from similar poses;

FIG. 6 is a diagram illustrating the concepts of a discrete spatial cube used in the example triangulation algorithm used in the 3-D mapping system of the example handheld apparatus of FIG. 3;

FIG. 7 is a diagram illustrating a group of 16 discrete spatial cubes, wherein the differing intensities of the hatching represent differing probabilities of a target lying within the corresponding discrete spatial cubes;

FIG. 8 is an orthographic view of a cluster of high-target probability discrete spatial cubes determined for a buried T-shaped PVC pipe section after processing to apply surfaces to the cluster so as to create a 3-D model of the buried T-shaped PVC pipe section; and

FIG. 9 is a hybrid image from a mixed-reality system that overlays a 3-D model of the buried T-shaped PVC pipe section (similar to the 3-D model of FIG. 8) overlaid onto a view of the setting in which the T-shaped PVC pipe section is buried.

### DETAILED DESCRIPTION

### General Description

In some aspects, the present disclosure is directed to methods of creating 3-D maps and/or corresponding 3-D images using a non-ranging feature-detection data, such as from one or more non-ranging feature-detection (NRFD) instruments that each senses and detects feature presence but does not generate ranging information or from one or more ranging feature-detection (RFD) instruments that each does generate ranging information but also feature-presence information. At a genus level, NRFD instruments and RFD instruments are also referred to herein as feature-detection (FD) instruments. As used herein and in the appended claims, “non-ranging feature-detection data”, also called “NRFD data” and simply “feature-presence data” herein and in the appended claims, are viewed from the perspective of the methods themselves, meaning that each method uses feature-presence data but not any ranging data that the FD instrument(s) used may generate.

More particularly, a “non-ranging instrument” is a sensor-based instrument that does not produce ranging data when each sensor of the non-ranging instrument is located at a discrete location wherein the NRFD instrument acquires data. For example, a non-ranging-type instrument does not acquire and/or process time-of-flight information that would provide ranging information. Correspondingly, a “non-ranging feature-detection instrument”, or “NRFD instrument”, is an instrument that detects one or more features of one or more objects, which may be any feature(s) of the object(s) that distinguish each object from its surroundings, but does not generate ranging information. On the other hand, a ranging feature-detection instrument”, or “RFD instrument”, is an instrument that detects one or more features of one or more objects but also generates ranging information. As discussed below, even if the FD instruments used generate ranging data, methods of the present disclosure do not use that information.

Generally, sensing feature presence is the ability to sense and indicate that a physical feature of an object is present. A physical feature can be any physical feature of an object that an FD instrument can sense. Examples of physical features include, but are by no means limited to, object boundaries (e.g., edges, sides, etc.), object surfaces (e.g., planar surfaces, curved surfaces, etc.), object material(s) (e.g., ferromagnetic material, energy absorptive material, energy reflective material, energy emitting material (e.g., heat emitting material, nuclear radiating material, etc.), electron flow, and presence and/or flow and fluid (e.g., liquid, gas, plasma, etc.), voids, delaminations, fractures, and temperature, among others, and any workable combination thereof.

At a high level, feature-presence data is acquired at multiple locations via the FD instrument(s), and pose data for each FD instrument is acquired in conjunction with acquiring the feature-presence data. A 3-D map depicting the sensed object(s) is created by operating upon both the feature-presence data and the pose data, for example, using a triangulation algorithm. In some embodiments, the 3-D map is used to create one or more 3-D images that can be displayed to a user, for example, in as near to real-time as possible, considering processing times and other physical limitations of the hardware implementing a method of the present disclosure. It is noted that while the term “3-D image” is sometimes used in this disclosure, such an image is constructed using 3-D data determined, for example, using a triangulation algorithm (see below). However, the corresponding image that is displayed to a user may be a 2-D image, for example, due to the type of graphical display used. However, in some cases, the displayed image may be a true 3-D image, with the user being able to visually perceive depth from the image, either with or without the aid of special viewing devices (e.g., filters), depending on the 3-D image-viewing technology involved.

In some embodiments, each FD instrument is a non-imaging sensing instrument (e.g., an A-scan-type sensing instrument), such as a radar-based instrument, a microwave-based instrument, a thermal instrument, an ultrasound instrument, or a laser-based instrument, among others, including either or both of NRFD instruments and RFD instruments. In some embodiments, each FD instrument is an imaging-type instrument (e.g., a pixeled array sensor or a B-scan-type sensing instrument), such as a visible-light imaging instrument, a thermal imaging instrument, a forward-looking radar instrument, a scanning-ultrasound instrument, or a scanning-laser instrument, among others, including either or both of NRFD instruments and RFD instruments. In some embodiments, each FD instrument may be a subsurface sensing instrument, such as a ground-penetrating radar (GPR) for subsurface investigation, a half-cell corrosion detector for concrete, a chain drag instrument and related acoustic instruments for delamination detection, a magnetometer, and an impact-echo instrument, including a portable seismic pavement analyzer instrument, among others. In some embodiments, one or more FD instruments of each a non-imaging type and an imaging type may be used. Fundamentally, there are no limitations on the type(s) of FD instrument(s) used as long as it/they indicate(s) presence of at least one physical feature of an object when that physical feature is actually present.

A 3-D map and/or 3-D image-creating method of the present disclosure may include acquiring feature-presence data at a plurality of differing locations using the one or more FD instruments. If a single FD instrument having a single sensor is used, then the sensor must be moved to the multiple locations. In some embodiments, a single sensor may be embodied in a handheld FD instrument such that the movement is controlled by the holder of the FD instrument. In some embodiments, a single sensor may be embodied in another form and moved by any other suitable means, such as a robot, land vehicle, airborne vehicle, etc. In some instantiations, the triggering of the FD instrument to acquire feature-presence data may be automatic or manual and continuous, continual, periodic, intermittent, or sporadic. In some embodiments, the triggering of feature-presence-data acquisition may be automatic and based on pose data. Fundamentally, there are no limitations on how the feature-presence data is acquired.

If multiple sensors are used, either in a single FD instrument or among multiple FD instruments, then the sensors may remain stationary and satisfy the requirement of acquiring feature-presence data from multiple locations. However, in some embodiments, the multiple sensors may be moved so that each sensor acquires feature-presence data from multiple locations. If the multiple sensors are moved, they may be moved in concert with one another (e.g., sensors rigidly fixed to a rigid support that is moved) or independently of one another (e.g., sensors independently moveably attached to a common support or sensors independent of one another). The multiple sensors may be operated in a monostatic mode wherein individual sensors launch and receive radiation directly reflected back from a subsurface feature, for sensing and analysis, in a bistatic mode wherein one sensor launches radiation, the radiation scatters at an oblique angle and a separate sensors receives and analyzes the signal, and in a multi-static mode where a sensor launches radiation and multiple sensors receive and analyze signals scattered obliquely.

A 3-D map and/or 3-D image-creating method of the present disclosure may include determining pose data for each of the sensors at each of the multiple locations. As mentioned above, the pose data is used in building a 3-D image using the feature-sensor data that the sensor(s) acquire. The pose data may be acquired using a pose estimator implementing any suitable pose-estimating technology, such as simultaneous location and mapping (SLAM) technology (e.g., visual-inertial SLAM (vi-SLAM), etc.), and photogrammetry technology, among others. Fundamentally, there is no limitation on the technology(ies) and/or methodology(ies) used to obtain the pose data. In embodiments using multiple sensors, each sensor or subgroup of sensors may have its own pose estimator, for example if the sensors or groups are independently movable. Alternatively, if the poses of the sensors in a multi-sensor embodiment are known relative to a local reference, such as if they are movable by way of corresponding robotic manipulators physically part of the same apparatus, then a single pose estimator may be used to estimate the pose of the local reference, and the global poses of the individual sensors may be determined using the pose of the local reference and local pose transformations.

In some embodiments, a pose estimator (e.g., a vi-SLAM system) can be integrated with each sensor/FD instrument. In some embodiments, a pose estimator may be located externally to each sensor/FD instrument. For example, a 3-D imaging system may be used to track the location of each sensor in a volume of space. In some embodiments using multiple sensors and/or multiple FD instruments, a first sensor/first FD instrument may include an integrated global pose estimator for determining pose data for that sensor or that FD instrument, with the pose data for the remaining sensor(s)/FD instrument(s) being determined by a local pose estimator that determines pose relative to the first sensor's/first FD instrument's pose. Those skilled in the art will readily understand the myriad ways that pose data for each sensor location where each sensor acquires feature-presence data can be acquired. In addition, those skilled in the art will readily appreciate the variety of manners in which the pose(s) of one or more sensors deployed on one or more FD instruments may be determined, such that an exhaustive explanation of many examples is not required for those skilled in the art to make and use the present invention to its fullest scope without undue experimentation.

In some embodiments, 3-D image creating methods of the present disclosure may include one or more visible-light cameras for acquiring images of the environment of the sensor(s)/FD instruments for creating images that include at least a portion of the 3-D map of the object(s) located in accordance with the foregoing features and aspects. In some embodiments, 3-D image creating methods of the present disclosure may use one or more image-generating instruments, for example, one or more forward-looking radar instruments, one or more laser-ranging instruments, one or more acoustic-ranging instruments, among others, for generating an image in which at least a portion of the 3-D map may also be displayed. For example, if the 3-D map is of one or more objects buried or otherwise present in or behind a physical barrier other than environmental air, the visible-light camera or image-generating instrument may provide an image of the exterior of the physical barrier through environmental air, with the 3-D map being over- or underlaid with the exterior image.

In some aspects, the present disclosure is directed to systems and apparatuses that implement one or more methods of the present disclosure, such as any one or more of the methods discussed above. Depending on the type of FD instrument(s) and the manner of deployment of such FD instrument(s), some embodiments may be characterized as a conventional presence-sensing instrument or system having an augmented reality (AR) “wrapper” figuratively wrapped around conventional components of such instrument or system. A detailed example of a single-frequency continuous-wave (CW) GPR device having an AR wrapper that uses one or more methods of the present disclosure to build 3-D images from presence data that the CW-GPR acquires and pose data from a vi-SLAM system and then integrate those 3-D images into an AR presentation is described in detail in the next section of this disclosure. It is noted that while a single-frequency CW-GPR is the subject of the detailed example in the next section, GPR-based embodiments can alternatively implement other types of FD instruments, such as wideband CW-GPR instruments, among others.

Those skilled in the art will readily appreciate that systems and devices implementing methodologies of the present disclosure are not necessarily limited to AR applications, nor the use of conventional presence sensors. For example, some embodiments may use the 3-D image generated from the feature-presence data and the pose data by itself, i.e., without overlaying the 3-D image onto a visible-light image. For example, the 3-D image generated may be displayed in conjunction with, for example, in an overlaid manner, with a virtual image of the subject region, such as a computer-generated map built using physical data. However, before addressing the detailed example, an example higher-level method and corresponding system are first described.

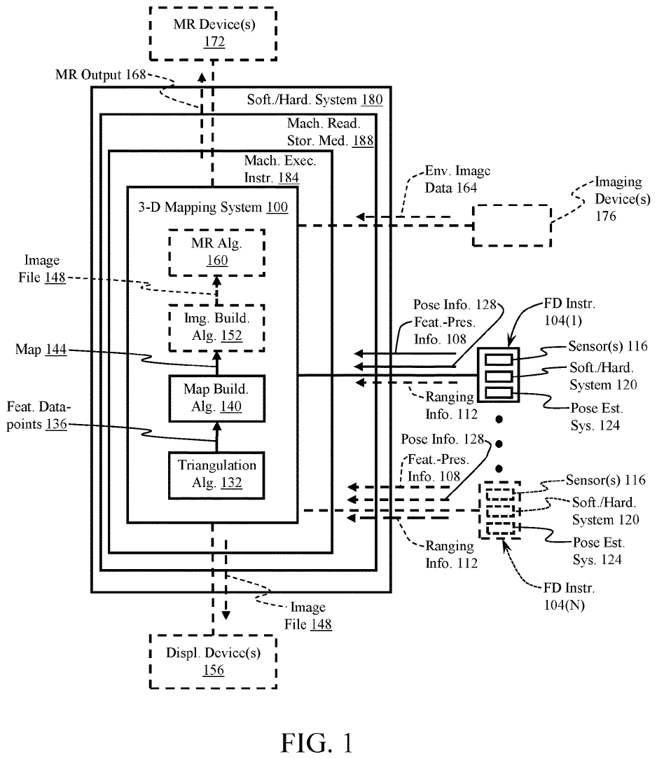

Referring now to the drawings, FIG. 1 illustrates an example 3-D mapping system 100 made in accordance with aspects of the present disclosure. As discussed above, a 3-D mapping system of the present disclosure, such as the 3-D mapping system 100 of FIG. 1, creates a 3-D map based on feature-presence information acquired using one or more FD instruments, such as any one or more of FD instruments 104(1) through 104(N) of FIG. 1, where N is any integer greater than 1. As discussed above, each FD instrument 104(1) through 104(N) may be any suitable NRFD instrument or RFD instrument, for example, any of such instruments mentioned above, among others. In this connection, each FD instrument 104(1) through 104(N) provides feature-presence information 108 to the 3-D mapping system 100, and, in cases of the FD instrument being an RFD instrument, the FD instrument may also provide ranging information 112, for example, when the RFD instrument does not have a feature to block outputting the ranging information. As noted above, if ranging information 112 is provided to the 3-D mapping system 100, then the 3-D mapping system may simply ignore it. Feature-presence information 108 may be provided to the 3-D mapping system 100 in any format, ranging from auditory information, visual information (e.g., lamp lighting), haptic information, analog electrical signal(s), or digital signal(s), and any practicable combination thereof, among others.

Although not shown, if the form of the feature-presence information 108 is not in the form needed for the 3-D mapping system 100 to perform its mapping operations, then any hardware and/or software (not shown, but such as transducer(s), analog-to-digital converter(s), signal conditioning circuitry, etc.) needed to convert the feature-presence information into the needed form may be provided internally and/or externally to the 3-D mapping system. Each FD instrument 104(1) through 104(N) includes one or more sensors (singly and collectively represented at 116) and any suitable hardware and/or software system 120 needed to operate the FD instrument. Those skilled in the art will readily understand the type(s) of the sensor(s) 116 and the hardware/software system 120 needed for each FD instrument 104(1) through 104(N). Indeed, a wide variety of sensor types and hardware/software system types are commercially available and can be used for the sensor(s) 116 and the hardware/software system 120.

In the example shown, each FD instrument 104(1) through 104(N) includes a pose-estimating system 124 that estimates the pose of that FD instrument and provides pose information 128 to the 3-D mapping system 100. Each pose-estimating system 124 may include any suitable hardware and/or software including, but not limited to, a triangulation-type system (e.g., GPS, beacon-based systems, etc.), an inertial measurement unit (EIMU), a vision-based system (e.g., a camera-based system), a radar-based system, an acoustic-based system, among others, and any practicable combination thereof, such as any combination known in the art. As mentioned above, each pose-estimating system 124 may use any suitable pose-estimating algorithm(s), such as, but not limited to, SLAM, vi-SLAM, and photogrammetry, among others, and any practicable combination thereof. It is noted that the example of FIG. 1 shows a pose-estimating system 124 aboard each of the FD instruments 104(1) through 104(N). However, in other embodiments, a pose estimation system (not shown) may be located offboard of the FD instrument(s). For example, a vision system located externally to the FD instruments 104(1) through 104(N) may use photogrammetry that use real-time images of the FD instrument(s) that the vision system capture in order to estimate the pose of each FD instrument present.

Each FD instrument 104(1) through 104(N) may communicate the feature-presence information 108, any ranging information 112 that may be present to the 3D mapping system 100 in any suitable manner, such as via any suitable wired or wireless means (not shown), including, but not limited to radio communications, light-based communication, sonic communications, ultrasonic communications, etc., and any practicable combination thereof. Fundamentally, there is no limitation on the manner(s) in which the feature-presence information 108 and/or the ranging information 112 is/are communicated to the 3D mapping system 100.

The 3-D mapping system 100 includes a triangulation algorithm 132 that operates on the feature-presence information 108 and the pose information 128, all in an appropriate digitized form, to generate feature datapoints 136 that the triangulation algorithm determined via triangulation of multiple feature-presence readings acquired, for example, when each of the FD instruments 104(1) through 104(N) utilized is at multiple differing locations and in multiple differing poses and/or when multiple FD instruments are in fixed differing locations and poses. In one example, the triangulation algorithm 132 may involve determining locations where presence-determination (e.g., sensing) axes of multiple readings intersect one another at an angle great enough that the probability of a detectable feature being present at or near the intersection is sufficiently high to indicate that that location of the intersection is properly a feature datapoint 136. A detailed example of such an intersection-type triangulation algorithm is described below in the next section of this disclosure. Triangulation algorithms for use as the triangulation algorithm 132 other than the intersection-type algorithm discussed below are possible, such as other intersection-type algorithms, including other intersection-type algorithms that are variants of the intersection-type algorithm described below. Indeed, the next section below describes some changes that can be made to the example intersection-type algorithm to create other intersection-type algorithms.

In the embodiment shown, the 3-D mapping system 100 includes a map-building algorithm 140 that effectively builds a map 144, or mesh, using the feature datapoints from the triangulation algorithm 132. As those skilled in the art will readily appreciate, the map 144 can be stored in any one or more suitable hardware storage memories (such as machine-readable storage medium 188 (see below)) and/or used for or in another process, such as building an image file/stream 148, for example using an optional image-building algorithm 152, depicting the map for display on one or more display devices (singly and collectively represented at 156). Those skilled in the art will readily understand how to implement the image-building algorithm 152 to generate any suitable image file/stream 148.

In some embodiments, the 3-D mapping system 100 may optionally provide an output, such as the map 144 and/or the image file 148 or image stream, to a mixed-reality (MR) algorithm 160 that uses the output and environment-image data 164 to create an MR output 168 to one or more MR display devices (singly and collectively represented at 172), such as a graphical display, MR goggles, and/or MR glasses among others. In some cases, the MR output 168 may be a fusion of images representing the map 144 and real-time environment images, via environment-image data 164, of the environment in which the mapped object(s) is/are present, while in other cases, such as for MR glasses, the MR output may be images of the map for projecting onto one or more lenses of the MR glasses. The environment-image data 164, when present, may be acquired via one or more imaging devices (singly and collectively represented at 176), such as one or more visible-light cameras, one or more thermal imagers, or one or more radar-based imagers, among others, and any practicable combination thereof. Those skilled in the art will readily appreciate the myriad ways that any output of the 3-D mapping system 100, such as the map 144, the image file/stream 148 or the MR output 168, can be used.

Regarding hardware for implementing the example 3-D mapping system 100 and other systems and/or devices illustrated in FIG. 1, those skilled in the art will readily understand that there are many ways in which these systems and/or devices can be embodied. Relative to the 3-D mapping system 100 itself, it can be implemented in any suitable software/hardware system 180, including, but by no means limited to, a system-on-chip software/hardware system, a centralized computing software/hardware system, a distributed computing software/hardware system, an on-cloud software/hardware system, and an edge-type software/hardware system, and any practicable combination thereof. Any or all of the models described and listed herein, or apparent from reading this entire disclosure, and any algorithms and/or any machine-executable instructions 184 needed for performing any function disclosed or suggested in this disclosure or apparent from reading this entire disclosure may be stored in any suitable machine-readable hardware storage medium 188, which includes any one or more hardware storage memories of any one or more of suitable types, including, but not limited to, long-term machine memory (flash memory, solid-state memory, ROM, optical memory, magnetic memory, etc.), short-term machine memory (e.g., RAM, cache, etc.). Fundamentally, there are no limitations on the type(s) of hardware storage memory(ies) that can be used. It is particularly noted that the term “hardware” in “machine-readable hardware storage medium” indicates the exclusion of any sort of transient medium, such as signals on a carrier wave and sequenced pulses that carry digital information. All of the foregoing and other software/hardware systems suitable for use as the software/hardware system 180 are ubiquitous and commonplace, and therefore need not be described in any more detail for those skilled in the art to make and use all features and aspects of this disclosure to their fullest scope without undue experimentation.

Those skilled in the art will understand that the other systems and devices illustrated in FIG. 1, such each FD instrument 104(1) through 104(N), the pose-estimating system(s) 124, each display device 156, and each MR device 172, among others, can similarly be implemented with any suitable software/hardware system that are the same as or similar to the software/hardware system 180 and that the software/hardware systems of any two or more of the systems and/or devices discussed can be combined with one another as needed to suit a particular design.

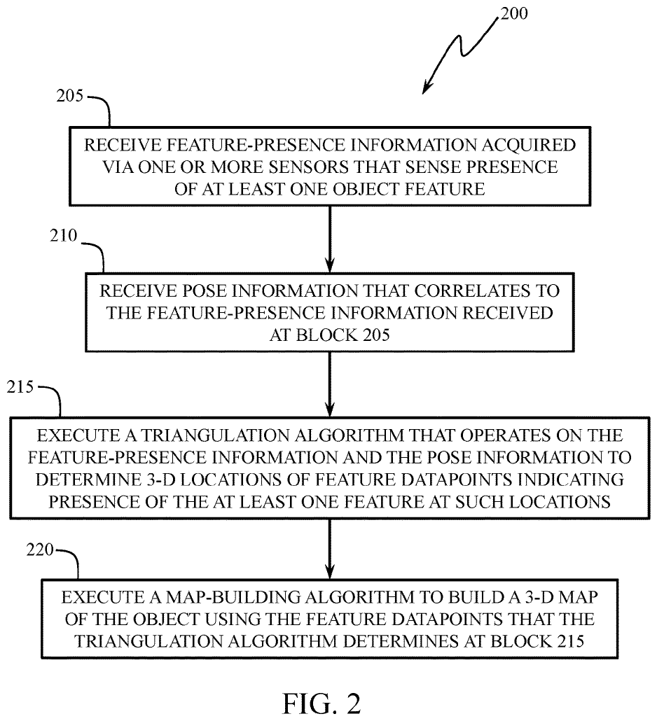

FIG. 2 illustrates an example method 200 of creating an image of an object. Referring now to FIG. 2, and also to FIG. 1 for occasional references thereto, the method 200 includes, at block 205, receiving feature-presence information acquired via one or more sensors that sense presence of at least one feature of the object. In the context of the example in FIG. 1, feature-presence data may be included in the feature presence information 108 that the 3-D mapping system 100 receives from one or more FD instruments 104(1) through 104(N) and may be in any suitable format for successfully performing the method 200.

At block 210, the example method 200 includes receiving pose information that correlates to the feature-presence information received at block 205. In the context of FIG. 1, the pose information received at block 210 corresponds to the pose information 128 that the 3-D mapping system 100 receives from the pose-estimating system(s) 124. In some embodiments, the received pose information denotes a position, in 3-D space, at which at least one piece of feature-presence data has been acquired, as well as an orientation of one or more sensors when the at least one piece of feature-presence data has been acquired. In the example of FIG. 1, the received pose information corresponds to pose information for each of the one or more FD instruments 104(1) through 104(N) used.

At block 215, the example method 200 further includes executing a triangulation algorithm, such as the triangulation algorithm 132 of the 3-D mapping system 100 of FIG. 1, that operates on both the feature-presence information and the pose information to determine locations of feature datapoints in 3-D space wherein the at least one feature of the object is estimated to be present. The triangulation algorithm at block 215 may be an intersection-type algorithm that finds 3-D locations where both the feature-presence information and the pose information indicate that multiple sensing axes intersect with one another to define a feature datapoint. The next section below titled “DETAILED EXAMPLES” provides a detailed description of such an intersection-type triangulation algorithm that can be executed at block 215. As described there, the triangulation algorithms determine that an intersection defines a valid feature datapoint only when an angle of intersection between the sensing axes is equal to or greater than a minimum threshold.

At block 220, the example method 200 includes executing a map-building algorithm, such as the map-building algorithm 140 of the 3-D mapping system 100 of FIG. 1, to build a 3-D map of the object using the feature datapoints that the triangulation algorithm determines at block 215. As discussed above, the 3-D map that the map-building algorithm builds at block 220 may be used for any of a variety of purposes, such as generating an image of the object, providing ranging information for the object, and generating MR images of the object, among other things.

### DETAILED EXAMPLES

The following examples are based on a single-frequency continuous-wave ground-penetrating radar (CW-GPR) as an experimental NRFP instrument, and specifically an AML PRO™ subsurface locator available from Subsurface Instruments, Inc., De Pere, Wisconsin. Consequently, many of the implementation details discussed below are specific to this particular NRFP instrument. However, using the following examples as a guide and where this disclosure is silent on the higher-level concepts undergirding any of the following examples or portion(s) thereof, those skilled in the art will readily be able to extract any relevant higher-level concept from the corresponding example and then apply such higher-level concept in a different implementation using only routine skill in the art. For example, while the experimental NRFP instrument operates at a particular frequency and includes a particular arrangement of antennas, alternative NRFP instruments that may be desirable to use may operate at one or more other frequencies and/or may have a differing antenna arrangement, among other differences. Regardless of any difference, those skilled in the art will readily be able to implement methodologies disclosed herein using any alternative instrument without undue experimentation.

As an introduction to the following examples, the experiments discussed below involve the use of a type of radar that is most commonly used in speed measurement applications (relying on the Doppler effect) and that uses a continuous wave (CW) transmission. This type of radar has advantages such as higher penetration and higher power-transmission efficiency, as well as lower interference with wireless devices, all relative to similarly sized and powered pulsed radar systems. These advantages have led to the development of CW ground-penetrating radar (GPR) instruments, such as the AML PRO™ subsurface locator mentioned above. A simple single frequency CW radar for ground-penetrating applications, however, has no inherent mechanism that allows range finding and, so, provides only an indication of whether a target object, or detectable feature thereof, is present or not within the beam envelope of the radar. For example, the AML PRO™ subsurface locator simply provides a beeping sound when a target object/detectable feature is present within the beam envelope. Pulsed radars, on the other hand, use the time of travel for each pulse to estimate range to a target device. There is no such start-and-stop point for a CW scan to compare against for time of travel, and, so, a CW-GPR cannot provide any ranging information and is, therefore, an NRFP instrument.

At a high level, to take advantage of the performance benefits of the example CW-GPR NRFP, this example includes a method wherein visual-inertial simultaneous localization and mapping (viSLAM) is used to triangulate targets that the CW-GPR has detected, similar to occupancy mapping. For every “positive” scan (wherein the CW-GPR detects a target) the system records the pose, i.e., the position and rotation, of the CW-GPR at the time of the scan. A list of poses corresponding to positive scans are the input to a triangulation algorithm. The triangulation algorithm uses a set of parameters corresponding to the size of the CW-GPR's scanning influence, as well as the sensitivity to scan intersection to produce a 3-D model, which, in this example, is in turn sent to a pair of mixed-reality goggles. Using the goggles, a user can view and interact with the 3-D model in mixed reality. Using apparatuses and/or systems made in accordance with the present disclosure, construction workers, search and rescue teams, and a host of other users, will be wearing holographic lenses whilst real-time scanning through walls, rubble of collapsed buildings, avalanche snow, and other materials, painting a 3-D map of their hidden surroundings. With that background, details of the example embodiments and experimentation follow.

### Materials and Hardware

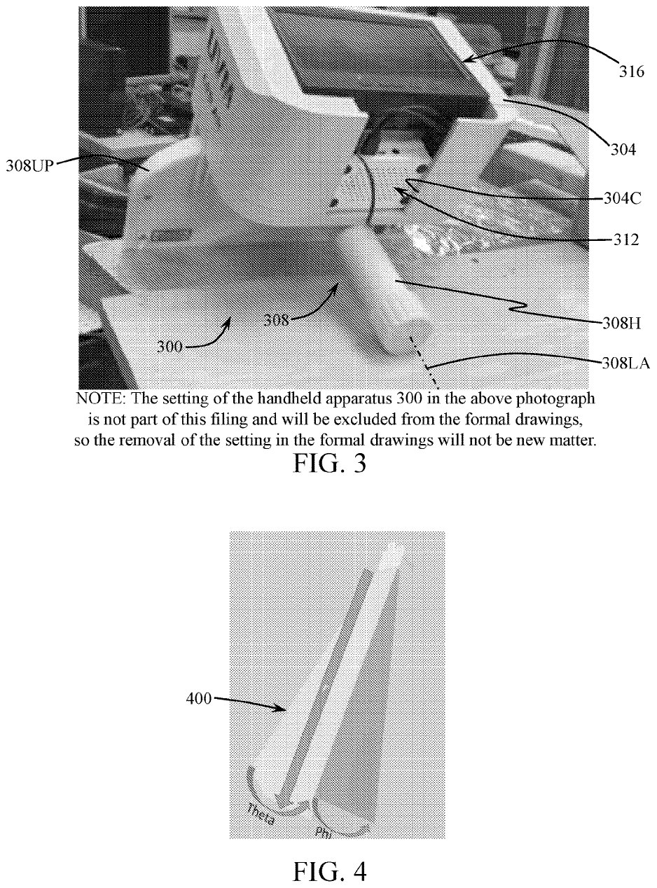

As those skilled in the art will readily appreciate, a large portion of this disclosure is directed to algorithms directed to the mapping techniques that are central to many embodiments of the present disclosure. Before proceeding to discussing examples of such algorithms, following is a brief overview of materials and hardware, as well as software and libraries, used to conduct experiments that proved efficacy of methods of the present disclosure. FIG. 3 illustrates a custom-made handheld apparatus 300 made for the experiments. The handheld apparatus 300 includes a custom casing 304 mounted to the back of the experimental NRFD instrument 308 mentioned above, which includes a handle 308H and an upper portion 308UP that houses the antennas and electronics of the NRFD instrument. The experimental NRFD instrument 308 is a CW-GPR that emits a continuous 2.4 GHz wave and measures the reflected phase difference with comparators throughout its antenna array of four receiving antennas (not seen) that are arranged in a plane within an upper portion 308UP of the NRFD instrument. Two of the receiving antennas are located on each side of a transmission antenna (not seen) located centrally within the upper portion 308UP of the NRFD instrument 308. The operating principle of this NRFD instrument 308 is that an outgoing CW signal from the transmission antenna causes a reflection in plane with the receiving antennas and when properly aligned relative to a detectable feature of a target object. The result is that the NRFD instrument 308 is a CW instrument that is polarized, meaning that it can detect long edges of an object and elongated objects, such as pipes and concrete reinforcing bars, that are aligned with its antenna plane, and it can do so with all of the advantages of a CW-based GPR mentioned above.

Inside the casing 304 is an electronics enclosure 312 that contains, among other things, a mobile computing device (not seen) (e.g., a Raspberry Pi® 4 device, available from the Raspberry Pi Foundation, Cambridgeshire, United Kingdom), that handles and stores the incoming data. Additionally, inside the electronics enclosure 312 is an op-amp circuit (not shown) that plugs into a 3.5 mm audio jack (not seen) on the NRFD instrument 308 to convert the beeping sound it emits when it detects a target into a 3v3 digital signal that general-purpose input-output (GPIO) pins of the mobile computing device can read. The NRFD instrument 308 of this example also includes a visual-display device 316 and forward-facing tracking camera (not seen), here a RealSense™ T265 tracking camera, available from Intel Corp., Mountainview California, that uses vSLAM techniques, such as an extended Kalman filter, to estimate states and produce pose data. This particular tracking camera is an example of a device that can provide drift-free local-positioning that is important to the success of the triangulation algorithm. In this example, the tracking camera is located beneath (relative to FIG. 3) the visual-display device 316 so as to have an optical axis (not shown) extending away from the casing 304, in a direction parallel to the longitudinal axis 308LA of the handle 308H, on the side of the casing opposite the side having the cutout 304C that reveals the electronics enclosure 312.

In order to visualize scanned targets this example handheld apparatus 300 uses a mixed-reality headset (not shown), here the HoloLens® 1 mixed-reality headset available from Microsoft Corporation, Redmond, Washington. This particular mixed-reality headset can execute spatial mapping using a depth camera, as well as perform pose estimation in a manner similar to the RealSense™ T265 tracking camera used for the tracking camera. In addition to this, the HoloLens® 1 mixed-reality headset has gesture recognition to interface with 3-D models in real time.

### Software and Libraries

The code for this example was written in the Python® 3.6 programming language both on the mobile computing device for data acquisition as well as on a personal computer (not shown) used for data processing. These two sets of code used similarly structured code files, because a long-term goal is to integrate them both and optimize to the point that the mobile computing device completes all of the calculations without the need for file transfer to another computer. Some code libraries used include the PyVista™ library and the Point Processing Toolkit (PPTK) library. The PPTK library allowed quick and computationally light visualization of point clouds including over 10,000,000 points, which was helpful for early iterations of the software before it was optimized. The PyVista library is a powerful tool for extracting the surface of a set of points in space and then using built-in algorithms to derive a mesh and save it as a solid object file (through Delaunay triangulation).

### Methods

The NRFD instrument 308, like any other radar, has a finite range and pattern where the signal is emitted. FIG. 4 shows the approximate shape of this pattern. The NRFD instrument 308 detects objects in the beam frustum 400 of a pyramid, and there are four main parameters defining this region. The beam frustrum 400 is defined in the triangulation algorithm by its height (r), the angles that it expands from the antenna are θ and φ (shown in FIG. 4 as “Theta” and “Phi”, respectively) as well as the width (w) of the upper portion 308UP containing the receiving antennas, as discussed above.

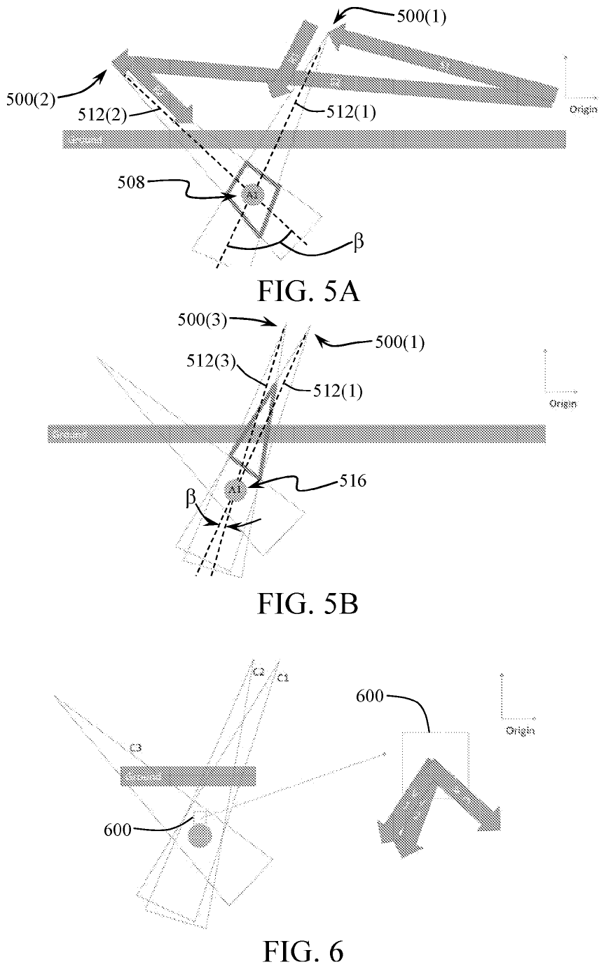

Referring to FIG. 5A, a concept behind the triangulation algorithm is that a target object A1 is likely to lie in a location observed by multiple scans, here, scans taken at locations 500(1) and 500(2), with Sᵢ denoting a corresponding position vector and R; denoting a corresponding direction of the NRFD instrument 308 (FIGS. 3 and 4) after being rotated to the orientation of the scan. Scans from very different locations, such as the scan from the locations 500(1) and 500(2) of FIG. 5A, that intersect also indicate a high likelihood of the presence of the target object A1. As illustrated in FIG. 5B, in a real life scanning scenario, multiple scans from nearby poses, such as illustrated poses at locations 500(1) and 500(3) may be positive. Using an angle of intersection β, the triangulation algorithm can differentiate between intersections, such as intersection 508 of FIG. 5A between the averaged beams 512(1) and 512(2) in this example, having a high probability of locating the target object A1 and intersections, such as intersection 516 of FIG. 5B between the averaged beams 512(1) and 512(3) in this example, having a low probability of locating the target object A1. In order to take this concept and computerize it, all of the geometry must be discretized.

As one step, a finite resolution was chosen. For rapid troubleshooting tests, a 10-cm resolution worked well, and for more accurate renderings, resolutions as high as 1 cm were used. A limiting factor here is the cubic-time complexity; for example doubling the resolution results in an 8-times increase in computing time. To initialize the triangulation algorithm, a 3-D array was created with dimensions just large enough to fully encapsulate the frustrum 400 in FIG. 4. A loop indexed through the array and logic statements to determine if a current index fell within the modeled frustum 400. The result was a discretized version of the scanning region contained in the array. A list of position vectors pointing to each index within the frustum 400 was also saved.

Next, for each pose estimation that the tracking camera (not seen) of the handheld apparatus 300 of FIG. 3 made and that the mobile computing device (not shown) recorded, a stored quaternion was applied to each position vector in the aforementioned list. Using quaternions and quaternion operations proved to be an effective and efficient way to process freehand rotations. Equation 1, below describes how a quaternion rotation q is applied to a vector, which is interpreted as quaternion p with real part equal to 0. The translation can then be simply added to the resultant p′. This final vector is then used to point to a discrete spatial block dS in a main array which represents the entire area being scanned.

$${p}^{′} = {qpq}^{- 1} \qquad ( 1 )$$

Definition: dSᵢⱼₖ is a discrete spatial cube in absolute space with side lengths equal to the spatial resolution. The location in the grand array is indicated by subscripts ijk wherein i, j, and k can be multiplied by the resolution to yield each dS location in actual space.

Referring to FIG. 6, each dSᵢⱼₖ represents the set of N vectors that are normal to each scan that intersected with a corresponding spatial cube 600 of space. In FIG. 6, each Cᵢ represents a scan that has encapsulated the particular spatial cube 600 shown, and each V, is a vector representing the direction of each scan Cᵢ, with i=1 to 3 in this example. For the sake of the triangulation algorithm, dSᵢⱼₖ has two weighting attributes, N and D, where Nis the number of scans and D is the minimum dot product between any two scan vectors. Scan vectors are determined by transforming the unit vector in the −\hat{k} direction, which is in the same direction as the receiving antennas of the NRFD instrument 308 (FIGS. 3 and 4) points, by the quaternion representing that scan's orientation. Each vector has magnitude of 1, meaning that all the dot products are simply equal to the cosine of the angle. Moreover, as this is mainly a ground penetrating application, there is no need to worry about angles beyond π radians as this does not make physical sense.

The quantity D is defined below in Equation 2, wherein vₘ and vₙ are vectors contained in the set at dSᵢⱼₖ, for all combinations in and n but m≠n up to N.

$$D = min ( {v}_{m} \cdot {v}_{n} ) \qquad ( 2 )$$

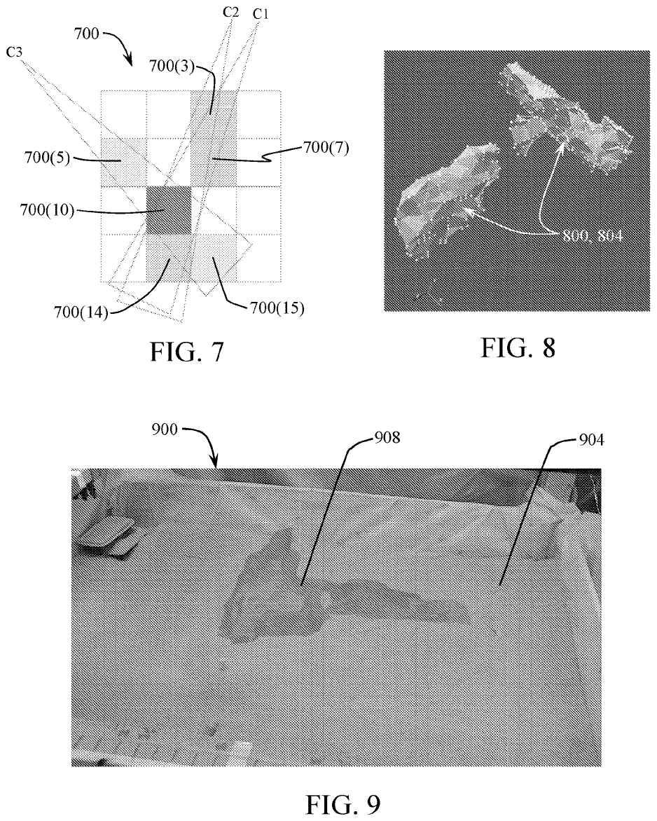

A spatial cube whose D value is very low indicates that some two scans intersected there at a very high angle. A spatial cube whose Nis very high indicates many scans intersected there. The key to the algorithm is to realize that neither of these two conditions are sufficient to say that there is a high probability of the target being present at this spatial cube. Rather, that relatively high N and low D at the same time lead to a high probability of a target. FIG. 7 helps visualize this concept at an extremely low resolution. FIG. 7 shows a 4×4 array 700 of spatial cubes 700(1) through 700(16) (only some labeled to avoid clutter), with differing levels of shading within the spatial cubes representing the probabilities that the target object is present in the various spatial cubes as determined by the triangulation algorithm. Here, the denser the shading, the higher the probability of the target object being present in that spatial cube. As is readily seen, spatial cube 700(10) wherein all three scans C1 through C3 intersect significantly has the highest probability of containing the target object, followed by spatial cubes 700(3), 700(7), and 700(14) wherein two of the three scans overlap significantly, followed by spatial cubes 700(5) and 700(15) wherein substantially only one scan is present.

Algorithm: Highlight each dSᵢⱼₖ with an N value above a certain threshold and a D value below a certain threshold. Note: neither of these values must necessarily be static. However, for the initial experiments, they were held static.

### Experimental Setups

Two main experimental setups were tested to verify different aspects of the example method of computing scan intersections. First, a 2.5 cm-diameter metal rod was placed on the ground behind a horizontal wooden barrier and scanned using the handheld apparatus 300 of FIG. 3 in order to verify that the triangulation algorithm was successfully differentiating between high- and low-angle intersections. This setup was designed to minimize geometric complexity and to use the simplest target object for the CW-GPR-based NRFD instrument 308 (FIGS. 3 and 4), specifically, a solid metal object (aluminum in this case). The second test setup was more complex and was designed to test the geometric capabilities of the system, as well as to showcase the advantages of using CW radar and the experimental NRFD instrument 308 in particular. This test setup used a section of 10-cm-diameter polyvinyl chloride (PVC) pipe about 1 m long with a T-joint at one end, with the entire section buried under moderately fine sand at a varying depth in a range of about 5 cm to about 15 cm.

### Experimental Results

The result of the first, more basic, test is shown in FIG. 7 of the appendix of U.S. Provisional Patent Application Ser. No. 63/326,365, filed Apr. 1, 2022, and titled “APPARATUSES, SYSTEMS, AND METHODS FOR BUILDING IMAGES USING SENSOR POSE INFORMATION” (“the '365 provisional application”), which is incorporated herein by reference in its disclosures of the experiments conducted using the experimental NRFD instrument 308 of FIG. 3. This test was successful, with low-intersection-angle zones being successfully excluded and the spatial cubes having high target-object-present probabilities being at the proper depth. The region containing the high-probability spatial cubes, which was approximately 25 cm wide, was clearly bigger than the 2.5-cm diameter pipe, but that was likely due to using values for 0 and φ in the triangulation algorithm that were too large, essentially modeling the scans thicker than they really were. Regardless, the point was not yet to generate a perfect 2.5-cm-diameter cylinder but to instead verify that the triangulation algorithm properly excluded low-angle spatial cubes corresponding only to low-angle scans, which it did.

The results of the second, more realistic, test setup are shown in FIG. 8 of the '365 provisional application. This data was collected in a few minutes by carefully moving the handheld apparatus 300 (FIG. 3) around above the sand and then making second passes over areas where the radar indicated presence of the target object (again, the T-shaped PVC pipe section). Then, in order to start finding scan intersections, second passes were made around the scanning zone at different angles to try to triangulate the depth and 3-D form of the target object.

FIG. 8 of the '365 provisional application shows the volume of spatial cubes of the intersection-analysis process of the triangulation algorithm. Using the PyVista™ library mentioned above, it was easy to extract the surface of this volume and then save it as a common solid file format, in this present example the stereolithography (.STL) file format, which was later converted to an Filmbox (.FBX) file format for compatibility with the HoloLens® mixed reality goggles. The calculated 3-D surfaces 800 of the spatial-cube volume 804 representing the T-shaped PVC pipe section that resulted from the data in FIG. 8 of the '365 provisional application is shown in FIG. 8. Clearly, the view shown in FIG. 8 is an orthographic view of that T-shaped PVC pipe. The scale of the 3-D model indicated that the T-shaped PVC pipe is about 20 cm in diameter, when in reality it was actually 10 cm. However, the important result is that the shape and general size are represented in the calculated volume 804 of the point cloud and the resulting surfaces 800.

An important point to make is that the uncalibrated triangulation algorithm was accurate but not very precise in these experiments. The volume 804 surrounding the T-shaped PVC pipe is about 200% oversized, but it indeed contained the true target. This could have been another case of not properly matching the real-world scan size with the model parameters φ and θ, or perhaps it had to do with the angular precision of the inertial measurement unit (TMU) of the tracking camera of the handheld device 300 of FIG. 3. A 1° error at the tracking camera would compound to almost 2 cm of error at 1 m distance from the handheld apparatus 300. Then, being 2 cm off in either direction coupled with the 2 cm resolution could have led to 4 cm of error on each side of the target, resulting in the 10-cm-diameter T-shaped pipe appearing to be 18 cm in diameter, which is not far off from the results achieved in this experiment. Of course, the differential could have resulted from a combination of the mismatched model parameters and IMU tracking errors.

### Augmented Reality Integration

The output FBX file mentioned above can simply be uploaded to the HoloLens® mixed-reality goggles and viewed in mixed reality with real-times images. In the experimental system, the 3-D model in the FBX file needed to be manually aligned with the environment using some anchor points that corresponded to a bounding box of the original scanning area. These could come in the form of any one or more of a variety of things, such as markers (e.g., caution cones, stakes, etc.), room corners, or walls, among other things, and any suitable combination thereof. FIG. 9 shows a hybrid image 900 of a view 904 through the HoloLens® mixed-reality goggles with the 3-D model 908 of the buried T-shaped PVC pipe displayed over the view. It is important to note that the HoloLens® mixed-reality goggles used a depth camera to compute a 3-D spatial map of the surroundings and by default, clips any 3-D holograms in view where they touch the spatial map. Consequently, visibility of the 3-D model was actually placed a few inches above its true location so that it could be seen clearly above ground. Other embodiments having a more sophisticated integration between the 3-D model of the target object and other images, such as visible-light images, can be readily made using only routine skill in the art.

### Example Improvements to Experimental System

The foregoing method of computing intersections weighted by angular components was successful in locating targets. However, changes can be made to improved accuracy and precision. For example, the thresholds of N and D values were static, meaning that, in a scanning session, if a certain feature is not scanned equally as many times as surrounding features, then that feature might not successfully pass above the predetermined threshold. This can lead to “dead zones” wherein the triangulation algorithm does not identify any positive spatial cubes for regions where the target object is actually present. In the above experiments, this likely happened when the user did not attempt to scan the dead-zone region as many times as they scanned the other regions, which is inherently challenging to keep track. The issue here is that the dead-zone region did indeed contain the target object or portion thereof, and the NRFP instrument 308 did indicate that by beeping appropriately, but the triangulation algorithm overlooked this fact because the thresholds for counting a positive spatial cube as containing the target object were static throughout the whole computation. Consequently, in some embodiments, the D and N threshold values can be adjusted dynamically, for example, on a per-scan basis.

As briefly mentioned above, the triangulation algorithm was executed offboard of the handheld apparatus 308 (FIG. 3) on a personal computer (not shown). Alternative embodiments can include modified triangulation algorithms that require less computing resources, and/or such alternative embodiments may include mobile computing systems having higher processing power so as to allow the handheld apparatus 308 to perform all of the computations onboard and in real time. In systems that include integrated mixed-reality goggles or other remote display device(s), a system made in accordance with the present disclosure may be augmented with wireless-network capabilities for uploading the 3-D images that the triangulation algorithm build to such remote display device(s). In addition, enhanced systems of the present disclosure may include automatic image anchoring so that the multiple images displayed to a user can be registered automatically with one another.

Also, it is worth noting that in more precise triangulation algorithms, Snell's law of refraction may be used to correct for refraction that happens to the radar transmission as it passes through regions where the speed of light is different. In the context of the present example, particularly between the ground and air, there is likely a significant deflection to the direction of the radar beam in accordance with Snell's law. Correcting for this could lead to higher precision of target estimation for a fixed spatial resolution. Nonetheless, the uncorrected results shown here indicate that this method of interpreting vi-SLAM enhanced radar scan data is actually promising and can help users visualize more clearly the hidden, buried or obscured structures that they are scanning.

It is noted, in connection with the beam frustrum 400 of FIG. 4, that the experimental version of the triangulation algorithm was simplified by assuming that all of the radar beams within the beam frustrum are parallel to the longitudinal central axis of the frustrum. However, in the real world, this is not so, because the angle that a beam forms with the central axis of the frustrum varies with the distance of that beam from the central axis. Consequently, more sophisticated embodiments of the triangulation algorithm can use more accurate representations of the three-dimensionally fanned-out beams.

Methodologies disclosed herein can be implemented for constructing non-ranging-signal-based 3-D maps of hidden objects through fog, through barriers, through ground, through darkness, or other visual hindrances, or any possible combination thereof.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A method of creating a 3-D map of an object, the method comprising:
receiving feature-presence data acquired via one or more sensors that sense presence of at least one feature of the object;
receiving pose information that correlates to the feature-presence data;
executing a triangulation algorithm that operates on the feature-presence data and the pose information to determine 3-D locations of feature datapoints indicating presence of the at least one feature at the 3-D locations; and
executing a map-building algorithm to build the 3-D map of the object using the feature datapoints.

2. (canceled)

3. The method of claim 1, wherein the feature-presence da is acquired using one or more non-imaging feature-detection instruments.

4. The method of claim 1, wherein the feature-presence is acquired using one or more non-ranging feature-detection instruments.

5. The method of claim 1, further comprising acquiring at least some of the feature-presence data and the pose information from a feature-detection instrument that includes a pose-estimating system.

6. (canceled)

7. The method of claim 5, wherein the feature-detection instrument comprises a continuous-wave radar instrument.

8. The method of claim 5, wherein acquiring the feature-presence data includes moving the feature-detection instrument so as to establish multiple differing poses at which the feature-presence data is acquired.

9. The method of claim 8, wherein the feature-detection instrument is a ground-penetrating radar instrument.

10. The method claim 9, wherein the ground-penetrating radar instrument is a continuous-wave ground-penetrating radar instrument.

11. The method of claim 5, further comprising determining the pose information using a simultaneous location and mapping (SLAM) system integrated into the feature-detection instrument.

12. The method of claim 11, wherein the SLAM system is a visual-inertial SLAM (vi-SLAM) system.

13. The method of claim 1, wherein the map-building algorithm build a 3-D mesh using the 3-D feature datapoints.

14. The method of claim 1, wherein the object is a visibly hidden object.

15. The method of claim 14, wherein the object is contained in at least one material.

16. (canceled)

17. The method of claim 1, wherein the triangulation algorithm is an intersection-type algorithm that uses the pose information to identify intersections of at least two feature-acquisition axes along which pieces of the pose information were acquired.

18. The method of claim 17, wherein each pair of feature-acquisition axes that intersect one another form an intersection angle, and validity of the feature datapoints is determined as a function of the intersection angle.

19. The method of claim 18, wherein the feature datapoints are deemed to be valid only if the intersection angle is equal to or greater than a predetermined minimum acceptable intersection angle.

20. The method of claim 1, further comprising determining the pose information using one or more simultaneous location and mapping (SLAM) systems.

21. The method of claim 20, wherein each SLAM system is a visual-inertial SLAM (vi-SLAM) system.

22. A machine-readable hardware storage medium containing machine-executable instructions for performing the methods of claim 1.

23. A 3-D mapping system, comprising:
a machine-readable hardware storage medium containing machine-executable instructions for performing the method of claim 1; and
a processing system in operative communication with the machine-readable hardware storage medium, wherein the processing system is configured to execute the machine-executable instructions so as to perform the method of claim 1.

24.-51. (canceled)
